(19) United States
(12) Patent Application Publication
(10) Pub. No.: US 2022/0242695 A1
(43) Pub. Date: Aug. 4, 2022

(54) TOUCH-SENSITIVE ELEVATOR OPERATION DEVICE FOR DIRECTION OF TRAVEL CALLS

(71) Applicant: INVENTIO AG, Hergiswil (CH)

(72) Inventors: Marcel ACKERMANN, Kirchberg (CH); Nicolas HÄFLIGER, Oberägeri (CH)

(21) Appl. No.: 17/625,681

(22) PCT Filed: Jul. 2, 2020
(86) PCT No.: PCT/EP2020/068689

§ 371 Date: Jan. 7, 2022

(30) Foreign Application Priority Data
Jul. 10, 2019 (EP) 19185457.9

(51) Int. Cl. B66B 3/00; B66B 1/46; B66B 1/34; G06F 3/0488; G06F 3/01; G06F 3/04817; G06F 3/16; G06F 3/044

(52) U.S. Cl. CPC B66B 3/002; B66B 1/468; B66B 1/3461; G06F 3/0488; G06F 3/016; B66B 3/02; G06F 3/167; G06F 3/0443; B66B 2201/463; B66B 2201/102; G06F 3/04817

(57) ABSTRACT

An elevator system in which an elevator car can be moved between floors in a manner controlled by an elevator controller is described. A car call device is communicatively connected to the elevator controller for inputting a destination floor is arranged in the elevator car. Elevator operation devices are communicatively connected to the elevator controller are arranged on the floors for the input of calls. An elevator operation device has a touch-sensitive screen system equipped with a substantially smooth touch surface and which responds with haptically perceptible feedback to a touch of the touch surface by a passenger.

### TECHNICAL FIELD

The technology described herein relates in general to an elevator system in a building. Embodiments of the technology relate in particular to an elevator system comprising elevator operation devices for passengers with physical disabilities, to a method for operating such an elevator system, and to an elevator operation device for such an elevator system.

### SUMMARY

In buildings having elevator systems, elevator operation devices, by means of which a passenger can call an elevator, are arranged on the individual floors. In known elevator systems, an elevator operation device arranged on a floor has mechanical push buttons by means of which the passenger can input the desired direction of travel (upward/downward). When one of these buttons is pressed, an elevator call is input, whereupon an elevator controller confirms the elevator call on the elevator operation device and provides an elevator car on the floor for boarding; for example, an elevator car is moved to the floor (boarding floor) and its elevator door is opened. In this elevator system, a car operation device (car call device) is provided, by means of which the passenger in the elevator car can input the desired destination floor.

The mentioned confirmation of the elevator call usually takes place visually and audibly. For this purpose, the elevator operation device has an illumination device and, for example, a buzzer, e.g., an electrically actuated acoustic signal generator that can generate an audible buzzing or beeping sound. The illumination device has, for example, for each button, a light source that lights up the pressed key or highlights it using a different light effect. An elevator operation device described in EP 1 633 669 B1 has these functions, for example. In addition to this, the elevator operation device described in EP 1 633 669 B1 confirms a pressed key by means of (haptic) feedback which can be perceived by the sense of touch and which, for example, can also be perceived by passengers with impaired vision.

Although in known elevator systems such elevator operation devices allow the desired direction of travel to be input and confirm the call input, including by means of haptically perceptible feedback, there may be additional requirements for the elevator operation devices depending on the building. These requirements can exist, for example, with regard to the design (e.g., size and shape), user-friendliness (in particular in view of passengers with physical disabilities, e.g., visually impaired passengers) and/or ease of maintenance. There is therefore a need for a technology that meets one or more of these requirements.

One aspect of the technology described herein relates to an elevator system having an elevator controller, an elevator car and elevator operation devices. The elevator operation devices are communicatively connected to the elevator controller and are arranged on the floors for the input of an elevator call. The elevator car can be moved between floors in a manner controlled by the elevator controller and has a car call device which is communicatively connected to the elevator controller and is intended for inputting a destination floor. An elevator operation device has a touch-sensitive screen system which is configured so as to have a substantially smooth touch surface and is configured to respond with haptically perceptible feedback to a touch of the touch surface by a passenger. The elevator controller is configured to actuate an elevator operation device in a normal operation mode of the elevator system by means of a first control signal such that the screen system displays at least one call symbol on the user interface. The elevator controller is also configured to actuate an elevator operation device in an emergency operation mode of the elevator system by means of a second control signal such that the screen system displays an emergency operation message on the user interface.

Another aspect of the technology relates to an elevator operation device for inputting an elevator call in such an elevator system. The elevator operation device has a communication device for communication with an elevator controller of the elevator system, a central control and processing device which is communicatively connected to the communication device, and a touch-sensitive screen system which is equipped with a substantially smooth touch surface and which is communicatively connected to the communication device. The screen system is configured to respond with haptically perceptible feedback to a touch of the touch surface by a passenger. The central control and processing device is configured, when actuated by the elevator controller in a normal operation mode of the elevator system, to actuate the screen system such that the screen system displays at least one call symbol on a user interface. The central control and processing device is also configured, when actuated by the elevator controller in an emergency operation mode of the elevator system, to actuate the screen system such that the screen system displays an emergency operation message on the user interface.

An additional aspect of the technology relates to a method for operating an elevator system comprising an elevator car, an elevator controller and elevator operation devices which are communicatively connected to the elevator controller and are arranged on floors for the input of an elevator call. An elevator operation device has a touch-sensitive screen system which is equipped with a substantially smooth touch surface and is configured to respond with haptically perceptible feedback to a touch of the touch surface by a passenger. According to the method, an elevator operation device is actuated by means of a first control signal generated by the elevator controller in a normal operation mode of the elevator system, whereupon a central control and processing device of the elevator operation device causes at least one call symbol to be displayed on a user interface of the screen system. According to the method, an elevator operation device is also actuated by means of a second control signal generated by the elevator controller in an emergency operation mode of the elevator system, whereupon the central control and processing device of the elevator operation device causes an emergency operation message to be displayed on the user interface of the screen system.

The technology described herein provides an elevator system in which an elevator operation device arranged on a floor, despite a touch-sensitive screen system having a substantially smooth touch surface, can be operated comfortably and reliably by passengers with and without physical disabilities. For example, a call symbol is visually displayed on the user interface. The input of an elevator call is confirmed by the haptically perceptible feedback. Passengers without physical disabilities can thus use the elevator operation devices in a usual and familiar manner.

Passengers with physical disabilities, for example impaired vision, blindness or limited mobility, can use the elevator operation device in the same way as passengers without such a disability. Since passengers with impaired vision cannot or can only very poorly identify a displayed call symbol and cannot feel said symbol on the smooth surface either, the elevator operation device supports the call input with the aid of haptically perceptible feedback. In one embodiment, an elevator operation device has an audio device for a voice message which is generated in connection with the haptically perceptible feedback. In this way, in particular passengers with physical disabilities are supported because they can orientate themselves better on the touch surface and can thus, for example, reliably input a desired direction of travel. The elevator system and in particular its elevator operation devices can thus be used by a large number of passengers.

In one embodiment, the call symbol displayed on the user interface depicts a push button or a symbol for a push button. The push button depicted can, for example, be modeled on a known electromechanical push button (e.g., in a round or rectangular shape). In another embodiment, the call symbol displayed on the user interface depicts a direction of travel symbol, for example, depending on the floor, for the upward or downward direction. On an intermediate floor, for example, the user interface displays a direction of travel symbol for the upward direction and a direction of travel symbol for the downward direction. The direction of travel symbols can be depicted, for example, as triangular symbols or as differently configured direction symbols, for example arrow symbols pointing up or down. A call symbol can also include a colored or monochrome light effect. A light effect can also be used to confirm a call input. The examples mentioned are indicative that the technology described herein allows a high degree of flexibility with regard to the depiction of a call symbol. In addition, passengers without physical disabilities can operate the elevator operation device intuitively.

In one embodiment, the screen system is configured to respond with the haptically perceptible feedback when the passenger touches the at least one call symbol and to identify input of an elevator call when the touch reaches a specified pressure force. This ensures that not every touch, e.g., an unintentional or accidental touch, leads to call input, but rather only if the passenger presses sufficiently hard on the call symbol.

In connection with the voice message, in one embodiment the screen system responds with a voice message to a light touch (e.g., a touch with a low pressure force). If the call symbol is at the point where the passenger touches the touch surface, the voice message informs the passenger of this; e.g., if a direction symbol is touched, the voice message indicates the direction of travel. If there is no call symbol or information field at this point, in one embodiment there is no voice message. If the voice message corresponds to the passenger's request (e.g., inputting an elevator call or inputting the direction of travel), the passenger can press the corresponding point harder to input the elevator call. This also supports passengers with a physical disability in operating the system. In addition, such a two-stage procedure increases the probability that only actual travel requests are registered.

In one embodiment, the touch-sensitive screen system comprises an actuator which, when actuated by a control voltage, causes a surface of the screen system to vibrate, the vibration being the haptically perceptible feedback. The type and strength of the vibration can in this case be specified in a flexible manner. The touch-sensitive screen system also includes a force measuring device and a control device. The force measuring device is configured to measure a force with which a passenger presses on the user interface of the screen system, the control device being configured to register the measured force as a triggering force only if the measured force reaches a specified threshold value. As already mentioned, this can reduce input errors caused by unintentional touching, since the passenger has to indicate their travel request by pressing harder.

In one embodiment, the elevator controller is configured to actuate an elevator operation device in the normal operation mode such that the screen system displays at least one information field in addition to the at least one call symbol, the screen system being configured to respond with haptically perceptible feedback when the passenger touches the at least one information field. The elevator controller terminal can thus be flexibly adapted to building-specific requirements. In addition, passengers can be informed conveniently, in an up-to-date manner and more extensively, for example regarding planned maintenance of the elevator system; however, it can also be indicated which service provider (e.g., doctor, dentist, lawyer, etc.) is on a particular floor.

In one embodiment, the information field displays information regarding a specified floor, for example which service provider is located on the floor. The elevator operation device is configured to generate, when the passenger touches the information field, the haptically perceptible feedback and a voice message assigned to the information field. The voice message can, for example, indicate the name of the service provider and the floor. If the passenger wishes to travel to or in the direction of this floor, they press the information field. If the pressure force is equal to a specified threshold value, the elevator operation device registers a request to travel in the direction of the specified floor. After boarding the elevator car, the passenger can input the desired floor on the car call device.

The technology described herein not only creates an elevator system and associated elevator operation devices that can be used comfortably and reliably by the majority of passengers, but also allows safety aspects to be taken into account. In one embodiment, an elevator operation device has a reader, communicatively connected to the elevator controller, for credentials of the passenger. The type of credentials can, for example, be adapted to circumstances in the building, for example said credentials can be selected in the form of a physical key, a manually input password (e.g., a PIN code), a biometric feature (e.g., fingerprint, iris pattern, facial features, speech/voice characteristics) or an access code captured from a magnetic card, chip card or RFID card or from a mobile electronic device (NFC-, Bluetooth- or cellular network-based). For passengers with physical disabilities, for example, a mobile electronic device can send the credentials to the reader wirelessly. If the credentials are valid, the elevator operation device approves the input of an elevator call. This means that only authorized passengers can call an elevator, as a result of which access to the elevator and thus also to the floors can be controlled.

The touch-sensitive screen system used in accordance with the technology described herein comprises a touch screen. A touch screen can be produced in different sizes or dimensions depending on the application and requirements. The size of the screen system can thus also be selected according to the requirements in the building such that, for example, a relatively small screen system can be selected if only the call symbol is intended to be displayed in the normal operation mode. If one or more information fields are also intended to be displayed, the size of the screen system can be selected accordingly.

In addition to this flexibility in terms of size, a touch screen also offers the advantage that it has a smooth surface. Dirt can be removed more easily from a smooth surface than, for example, from an arrangement that has one or more buttons having elevations and/or grooves and gaps. This reduces the maintenance effort.

The technology described herein also allows freedom in terms of design, for example with regard to the shape of an elevator operation device on the passenger side. Their housings can, from the passenger's perspective, be rectangular, for example, with it being possible for the touch screen to be arranged either in parallel with the vertical (wall) or (for better ease of use (viewability)) inclined with respect thereto. In particular in buildings for which a contemporary or modern appearance is desired, the elevator operation devices equipped with touch screens can help to achieve this goal.

### BRIEF DESCRIPTION OF THE DRAWINGS

Various aspects of the improved technology are described in greater detail below with reference to embodiments in conjunction with the drawings. In the drawings, identical elements have identical reference signs. In the drawings:

FIG. 1 is a schematic representation of an example of a situation in a building having a plurality of floors and an example of an elevator system;

FIG. 2 is a schematic representation of an example of a first user interface of an elevator operation device which is arranged in the elevator system according to FIG. 1 on a floor;

FIG. 3 is a schematic representation of an example of a second user interface of the elevator operation device;

FIG. 4 is a schematic representation of the elevator operation device and examples of components; and

FIG. 5 is an example of a representation of an embodiment of a method for operating the elevator system.

### DETAILED DESCRIPTION

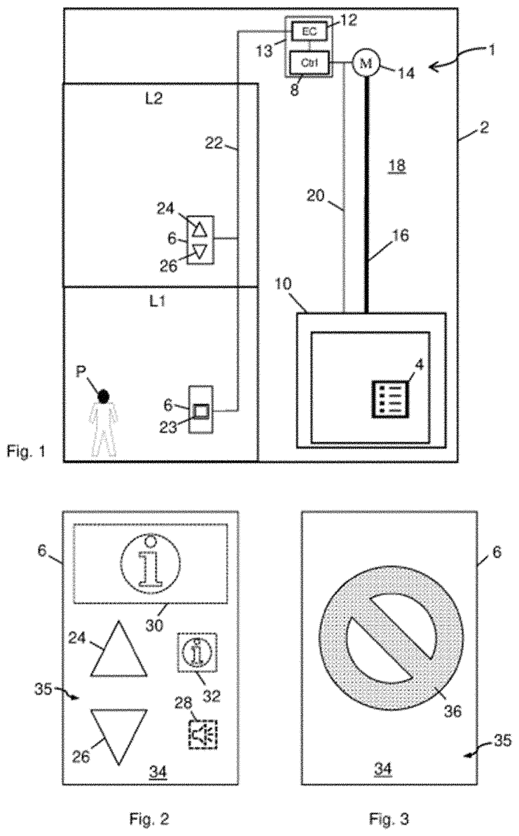

FIG. 1 is a schematic view of an example of a situation in a building 2 which has a plurality of floors L1, L2 that are served by an elevator system 1. The floor L1 can be an entrance hall of the building 2, into which hall the passengers P enter when accessing the building 2 and from which the passengers leave the building 2 again. If a passenger P enters the floor L1, each floor L2 of the building 2 served by the elevator system 1 can be reached from there, with appropriate access authorization. For the purpose of illustration, of the elevator system 1, only an elevator controller 13, a drive machine 14, a suspension means 16 (e.g., steel cables or flat belts), an elevator car 10 (hereinafter also referred to as car 10), which is suspended on the suspension means 16 and is movable in a shaft 18, and a number of elevator operation devices 6, which are communicatively connected to the elevator controller 13 by means of a communication network 22, are shown in FIG. 1. A person skilled in the art would recognize that the elevator system 1 can also comprise a plurality of cars 10 in one or more shafts 18 that are controlled by a group controller. Instead of a traction elevator (shown in FIG. 1), the elevator system 1 can also have one or more hydraulic elevators.

In the embodiment described herein of the elevator system 1, the passenger P on one of the floors L1, L2 inputs a travel request at an elevator operation device 6 arranged there, as a result of which an elevator call is registered. The floor L1, L2 on which the passenger P is located and from which they would like to be transported to a destination floor is also referred to below as the boarding floor. As explained in more detail elsewhere in this description, the passenger P can touch a call symbol (23, 24, 26) to input the call, whereupon the registration of the elevator call on the elevator operation device 6 is confirmed to the passenger P. The elevator controller 13 then makes an elevator car 10 available on the boarding floor for boarding, that is, if the elevator car 10 is not on the boarding floor, it is moved there and its elevator door is opened, otherwise the elevator door of the elevator car 10 already standing there is simply opened. In the elevator car 10, the passenger P can then input a desired destination floor at a car call device 4 arranged therein. The car call device 4 is connected to the elevator controller 13 by means of a communication line 20.

According to the embodiment shown in FIG. 1, the elevator controller 13 consists of two subsystems: a control system 8 and a group control system 12. The control system 8 controls the movement of the elevator car 10, while the group control system 12 determines the “best” elevator car 10 from a group of elevators or elevator cars 10. For the purpose of illustration, however, FIG. 1 only shows an elevator car 10 or an elevator. The group control system 12 checks, for example, which elevator is available and/or which elevator is closest to the boarding floor. This procedure is known to a person skilled in the art, and therefore further explanations in this regard do not appear to be necessary. The control system 8 actuates the drive machine 14 such that, inter alia, the allocated elevator car 10, together with the passenger P, is moved from the boarding floor to the destination floor. A person skilled in the art would recognize that, in an embodiment with a plurality of elevators, each elevator has a control system 8 and that, in an embodiment with only one elevator, the group control system 12 can be omitted.

According to the embodiment shown in FIG. 1, on each floor L1, L2 an elevator operation device 6 is arranged, each elevator operation device being communicatively connected to the elevator controller 13 via the communication network 22. In one embodiment, each elevator operation device 6 has a housing which, for example, is arranged on or completely or in part in a building wall in the access area to a floor-side elevator door (elevator shaft door). In one embodiment, the elevator operation devices 6 are supplied with electrical energy via the communication network 22, for example by means of a technology known as Power over Ethernet (PoE).

The elevator system 1 can be in a normal operation mode or an emergency operation mode. In the normal operation mode, there are no disruptions or restrictions in the elevator system 1 and passengers are transported according to their transport requirements. The normal operation mode also includes operation during times of high or low passenger volume. In the emergency operation mode, in contrast, there are disruptions or restrictions that can be system-related or building-related. In the elevator system 1, repair or maintenance may be required, for example. In this case, for example, a technician switches the elevator system 1 into a maintenance mode in which the elevator system 1 is completely or partially out of operation from the passenger's perspective. In one embodiment, the elevator controller 13 actuates the elevator operation devices 6 by means of a control signal so that said devices signal the unavailability of the elevator system 1. Building-related disruption is present, for example, if there is a danger alarm, for example a fire alarm, in the building 2. The fire alarm can be, for example, transmitted by a building management system. In this case, the instruction not to use the elevator usually applies and the elevator system 1 can be completely or partially out of operation. In this case too, according to one embodiment, the elevator controller 13 actuates the elevator operation devices 6 by means of a control signal so that said devices signal the unavailability of the elevator system 1. If there are no disruptions or restrictions, the elevator controller 13 actuates the elevator operation devices 6 in accordance with the normal operation mode.

FIG. 2 shows a schematic representation of an example of a user interface 34 of an elevator operation device 6 which is arranged in the elevator system 1 according to FIG. 1 on a floor L1, L2. In this case, the elevator system 1 is in the normal operation mode, the elevator controller 13 actuating the elevator operation device 6 by means of the corresponding control signal. The elevator operation device 6 comprises a touch-sensitive screen system comprising a touch-sensitive (sensor) screen (hereinafter also referred to as a touch screen) which generates the user interface 34 and displays said interface visually to the passenger P. The user interface 34 is a graphical user interface (GUI) and allows communication between the passenger P and the elevator system 1. The passenger P can, for example, select a displayed graphic symbol or control element by touch, for example in order to select the direction of travel. If the passenger P touches the selected symbol, the elevator system 1 or the elevator operation device 6 confirms this touch to the passenger P.

In the embodiment shown in FIG. 2, the user interface 34 displays a direction of travel symbol 24 for the upward direction and a direction of travel symbol 26 for the downward direction. The upward direction is symbolized by an upward pointing triangle, and the downward direction is symbolized by a downward pointing triangle. The elevator operation device 6 arranged on the floor L2 in FIG. 1 displays such direction of travel symbols 24, 26. As an alternative to these triangular direction symbols 24, 26, differently configured direction symbols can also be displayed, for example arrow symbols pointing up or down. In addition, the direction of travel symbols 24, 26 can be supplemented by text.

In FIG. 1, the elevator operation device 6 arranged on the floor L1 displays only one call symbol 23. The call symbol 23 is, for example, rectangular, but it can also have another shape, for example round or oval. If the passenger P touches this call symbol 23, this triggers an elevator call, e.g., a movement of the car 10 to the boarding floor (L1) without information regarding the direction of travel desired by the passenger P being communicated. A person skilled in the art would recognize that all elevator operation devices 6 in the building 2 can display the call symbol 23. Alternatively, all elevator operation devices 6 can display the call symbols 24, 26. A person skilled in the art would also recognize that an elevator operation device 6 on an intermediate floor can have two direction of travel symbols 24, 26 (or direction of travel buttons), one for downward travel and one for upward travel, while on a bottom or top floor, only one direction of travel symbol 24, 26 (up or down, respectively) can be displayed. A person skilled in the art would also recognize that, in the building 2, one or more elevator operation devices 6 can display the call symbol 23, while others can display the direction of travel symbols 24, 26. The following is a description of the technology with reference to the direction of travel symbols 24, 26.

In one embodiment, the user interface 34 has a size, e.g., specified as width and length (or height) or as screen diagonal, which can depend on the (physical) size of the touch screen. The screen diagonal can, for example, be between approximately 4 and approximately 24 inches. In another embodiment, the size of the user interface 34 can also depend on which area or which portion of the touch screen is defined as a usable area (for touching and/or displaying information). A person skilled in the art would recognize that the size of the user interface 34 can be selected in accordance with the requirements specified for the building 2. If, in the normal operation mode, for example, only the direction of travel symbols 24, 26 are to be displayed in a size sufficient for operation, the size of the user interface 34 can be selected accordingly, e.g., a relatively small touch screen can be used.

As indicated in FIG. 2, the size of the user interface 34 can also be selected such that additional fields and/or symbols can be displayed, e.g., information fields 30, 32 and an audio symbol 28. These are shown in dashed lines in FIG. 2 as optional fields and symbols. The additional fields and/or symbols can be positioned and dimensioned on the user interface 34 depending on the requirements in the building 2, e.g., it can be specified where and in what size they are displayed; the same applies to the shape and number of additional fields and/or symbols. A person skilled in the art would recognize that the direction of travel symbols 24, 26 and the additional fields and/or symbols can be graphically configured in a user-friendly manner, for example the direction of travel symbols 24, 26 can be displayed as buttons or pushbuttons in order to allow intuitive operation. If the passenger P presses one of these direction of travel symbols 24, 26, this pressed button is identified in one embodiment by a light effect.

The audio symbol 28 can, for example, be a symbol for a loudspeaker which is arranged in the elevator operation device 6. The information field 30 can display, for example, the elevator that serves the call, the waiting time until the elevator arrives, a direction of movement of the elevator, or an indicator that indicates the occupancy of the elevator. The information field 30 can also be used to display floor-specific and/or building-specific information. For example, it can be indicated in the information field 30 that the practice or office space of a service provider (doctor, dentist, lawyer) is located on a particular floor. If necessary, it can be indicated in the information field 30, for example, when planned elevator maintenance takes place or that a floor is currently inaccessible. The information field 32 can indicate, for example, the floor L1, L2 on which the elevator operation device 6 is arranged. This makes it easier for a passenger P to orientate themself in the building 2, for example.

FIG. 3 shows a schematic representation of an example of a user interface 34 of the elevator operation device 6; the elevator system 1 is in the emergency operation mode, the elevator controller 13 actuating the elevator operation device 6 by means of the corresponding control signal. In this emergency operation mode, the user interface 34 no longer displays the direction of travel symbols 24, 26 shown in FIG. 2 or the call symbol 23 shown in FIG. 1, but provides information that the elevator system 1 is currently not usable. This information is provided by means of an emergency operation message. According to the embodiment shown in FIG. 3, the emergency operation message includes a notification symbol 36. The notification symbol 36 can have the meaning of a prohibiting symbol or warning symbol and, for example, indicate that the elevator cannot be used due to a fire, an earthquake or another dangerous situation. The information symbol 36 can be supplemented by text and/or additional symbols. In another embodiment, the emergency operation message can be an image, text (one or more words) or a combination of image and text, for example it can be stated that the elevator system 1 is currently being serviced; in this case, an expected end of maintenance, a picture of the technician and/or contact information of the technician can be displayed.

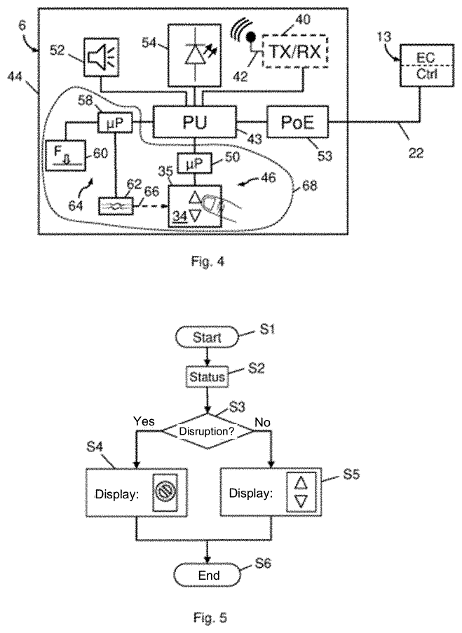

In the situation shown in FIG. 1, the technology described herein can be used in an advantageous manner. Briefly and as an example, the technology described herein provides an elevator system 1 in which the electromechanical push buttons typically present on the floors are replaced by elevator operation devices 6, each of which has a touch-sensitive screen system 68 equipped with a substantially planar touch surface 35 (see FIG. 4). If a passenger P touches a call symbol (23, 24, 26) to input an elevator call, the screen system 68 responds with haptically perceptible feedback. In one embodiment, acoustically perceptible feedback can also be generated. Although the call symbol 23 or the direction of travel symbols 24, 26 are not or only poorly visible to a passenger P with impaired vision and also cannot be felt on the smooth touch surface 35, this passenger P is supported in inputting the call. Passengers P without such a disability can identify the displayed call symbol 23 or the displayed direction of travel symbols 24, 26 and thus input calls in the usual way.

FIG. 4 shows a schematic representation of an example of an elevator operation device 6 which is arranged in the elevator system according to FIG. 1 on a floor L1, L2. The elevator operation device 6 is communicatively connected to the elevator controller 13 via the communication network 22. The elevator operation device 6 comprises a carrier apparatus 44 on which the components specified below are arranged. In one embodiment, the carrier apparatus 44 is configured as a housing, as a result of which the elevator operation device 6 can be arranged on a building wall or so as to stand on the floor. A person skilled in the art would recognize that such a housing may not be necessary if the elevator operation device 6 is installed completely or in part in a building wall or in a door frame of a floor-side elevator door. A person skilled in the art would also recognize that the elevator operation devices 6 are arranged at a height that is user-friendly or prescribed by a standard. In the following description of the technology, the carrier apparatus 44 is configured as a housing and is referred to as “housing 44.”

In the embodiment shown, the following are arranged on the housing 44 of the elevator operation device 6: the screen system 68 comprising a touch screen 46; a communication device 53 (PoE); and an illumination device 54. In one embodiment, the touch screen 46 has a transparent glass cover which closes the housing 44 externally or on the user side. The outer surface of the glass cover is a touch surface 35 which the passenger P touches, for example when inputting a call. A person skilled in the art would recognize that the glass cover can have a planar or curved glass plate. Regardless of the specific shape of the glass cover, its outer surface feels smooth to the passenger P, e.g., it has no elevations, depressions, roughening or Braille markings, for example.

The components arranged on the housing 44 constitute the user interface 34, the communication (including the energy supply) and the lighting. An electroacoustic transducer 52 (e.g., a loudspeaker) can be provided, in particular in connection with the audio symbol 28, in order to generate acoustic feedback (voice message), e.g., when touching the touch screen 46. The touch screen 46 comprises a processor 50 and the user interface 34, on which two triangular symbols for the directions of travel are illustrated in FIG. 4. The processor 50 is connected to a central control and processing device 43 (PU) and communicates, for example, with the elevator controller 13 and detects a signal when a passenger P touches the touch surface 35 using a finger.

The illumination device 54 is used to illuminate the user interface 34 of the elevator operation device 6, or only regions of the user interface 34. In a manner controlled by the central control and processing device 43, the illumination device 54 can light up the user interface 34 such that the displayed direction of travel symbols 24, 26 and the potentially displayed information fields 30, 32 can be perceived by a passenger P, in particular in poor lighting conditions. The illumination device 54 can also illuminate the user interface 34 or individual ones of the direction of travel symbols 24, 26 and the information fields 30, 32 with colored light in order to confirm the input of an elevator call to the passenger P, for example. In one embodiment, the illumination device 54 comprises one or more LED light sources.

In one embodiment of the elevator operation device 6, the touch screen 46 is combined with a feedback device 64, resulting in the touch-sensitive screen system 68. For the purpose of illustration, the screen system 68 is bordered by dashed lines in FIG. 2; a person skilled in the art would recognize that this border is by way of example and more or fewer components can be understood to belong to the screen system 68. The mode of operation of the user interface 34 is modified by the feedback device 64, as a result of which supported operation by means of haptically perceptible feedback is made possible. If the user interface 34 is touched at one point with a sufficient pressure force, haptically perceptible feedback occurs in response to this touch. Depending on the design, the haptically perceptible feedback can be accompanied by a vibration noise and/or a voice message, for which the electroacoustic transducer 52 is provided. A haptically perceptible feedback module created from such a combination of a touch screen and a user interface guided by touch can be obtained, for example, from the company next system Vertriebsgesellschaft, Vienna, Austria.

The feedback device 64 shown in FIG. 4 comprises a force measuring device 60 (e.g., in the form of a thin layer of capacitive pressure sensors), an actuator 62 and a control device 58 which is connected to the force measuring device 60 and the actuator 62. The force measuring device 60, in conjunction with the control device 58, measures the force with which the passenger P presses on the touch surface 35 or the user interface 34 of the touch screen 46. The force measuring device 60 detects the smallest changes in a distance between the (flexible) glass plate and the thin layer of capacitive pressure sensors or an underlying layer. In one embodiment, the control device 58 is configured such that it only registers the measured force as a triggering force if the measured force reaches a specified threshold value; only then is the touch considered to be deliberate pressing or deliberate input.

In one embodiment, the actuator 62 comprises two electrode plates, a first electrode plate being configured as a conductive grid and being rigidly connected to the glass cover, and a second electrode plate being connected to the touch screen 46 for common movement. A restoring element holds the electrode plates at a desired spacing. Such an arrangement can be referred to as an electrostatic parallel plate actuator. If the control device 58 actuates the actuator 62 by applying a voltage, the parameters of which, such as voltage, frequency, rising and falling edges can be specified (e.g., after exceeding the triggering force), the electrode plates move relative to one another counter to a force exerted by the restoring element; the glass cover moves accordingly, as a result of which the haptically perceptible feedback is generated. The effect of the actuator 62 on the touch surface 35 is indicated by an arrow 66 in FIG. 4.

Depending on the design of the elevator operation device 6, a reading device 40 for credentials of a passenger P can be arranged on the housing 44. The reading device 40 can be provided, for example, if the passenger P first has to identify themself as authorized before the elevator operation device 6 can be enabled for the call input. The credentials can, for example, be in the form of a physical key, a manually input password (e.g., a PIN code), a biometric feature (e.g., fingerprint, iris pattern, speech/voice characteristics) or an access code captured from a magnetic card, chip card or RFID card or from an electronic device (NFC-, Bluetooth- or cellular network-based). The passenger P presents the credentials when they want to input the desired direction of travel. The reading device 40 is configured in accordance with the credentials provided in the elevator system 1. This means that the reading device 40 has, for example, a key cylinder, a device for capturing a biometric feature, a device for capturing an optical code, a reader for a magnetic stripe card or a chip card, a keypad or a touch-sensitive screen for manually inputting a password, or a transmitting and receiving device for radio signals. The credentials captured by the reading device 40 are forwarded to the elevator controller 13, which carries out or initiates the authorization check, for example by checking whether the authorization code captured is assigned to an authorized passenger in a database. The check can be carried out, for example, by an access control function of the elevator system 1 or of an access control system. If the passenger P is authorized to access, the elevator operation device 6 can be enabled.

In the embodiment shown in FIG. 4, the reader 40 is a transmitting and receiving device for radio signals (TX/RX) and has an antenna 42. The reader 40 is also referred to below as a transmitting and receiving device 40 for radio signals (the transmitting and receiving device 40 is shown in dashed lines as an optional component). In order to make the call input possible, the transmitting and receiving device 40 can comprise an RFID reader or a radio module which communicates with a portable communication device (e.g., mobile radio/mobile phone, smartphone, tablet PC) of a passenger P. As an alternative to the transmitting and receiving device for radio signals 40 or in addition, a reader for an optical code presented by the passenger P (for example a barcode, QR code or color code) can be provided.

The communication network 22 connects the elevator operation devices 6 to the elevator controller 13 and thus makes communication possible between the elevator controller 13 and the elevator operation devices 6. For this communication, the elevator operation devices 6 and the elevator controller 13 can be directly or indirectly connected to the communication network 22. The communication network 22 can comprise a communication bus system, individual data lines, or a combination thereof. Depending on the implementation of the communication network 22, individual addresses and/or identifiers can be allocated to the elevator controller 13 and each elevator operation device 6, such that, for example, the elevator controller 13 can send a message to a desired elevator operation device 6 in a targeted manner. Communication can take place in accordance with a protocol for wired communication, for example the Ethernet protocol. As mentioned, in one embodiment the elevator operation devices 6 are supplied with electrical energy via the communication network 22 (PoE).

In one embodiment, the central control and processing device 43 is configured to put the elevator operation device 6 into an inactive state in order to reduce its consumption of electrical energy. In this standby or energy-saving state, the control and processing device 43 switches off the illumination device 54, for example; the user interface 34 then appears in one embodiment as a dark (black) area. The switch-off can take place if no passenger has been at or in the vicinity of the elevator operation device 6 for a set period of time. For this purpose, a sensor (not shown in FIG. 4) which detects the presence and/or a movement of a passenger can be provided in the elevator operation device 6. The sensor can be a motion sensor that operates according to one of known functional principles, e.g., actively using electromagnetic waves (RF, microwaves or Doppler radar), using ultrasound (ultrasonic motion detector) or passively using infrared radiation (PIR sensor, pyroelectric infrared sensor) from the environment. If the elevator operation device 6 is in the energy-saving state and the motion sensor detects the presence of a passenger P, the central control and processing device 43 switches the elevator operation device 6 to an active state in which, for example, the direction of travel symbols 24, 26 are displayed.

A person skilled in the art would recognize that the passenger P can input the destination floor on the car call device 4 in the elevator car 10. For this purpose, the car call device 4 can be configured according to one of several known technologies (for example electromechanical push buttons for the destination floors or corresponding fields (“buttons”) on a touch screen). In one embodiment, the car call device 4 is equipped with a touch-sensitive screen system and a feedback device in a manner analogous to the technology of the elevator operation devices 6. As stated above, the feedback device supports operation by means of haptically perceptible feedback.

With the understanding of the above-described elevator system 1 and its basic system components and functions, a description of an example of a method for operating the elevator system 1 shown in FIG. 1 is given below with reference to FIG. 5. FIG. 5 shows an example of a flow chart of the method; it begins at step S1 and ends at step S6. A person skilled in the art would recognize that the division into these steps is by way of example and that one or more of these steps may be divided into one or more sub-steps or that a plurality of the steps may be combined into one step.

The method is described with reference to a passenger P having one of the physical disabilities mentioned. It is assumed here that the passenger P is on a floor L1, L2 within reach of an elevator operation device 6 arranged there and would like to input an elevator call at said device in order to call an elevator to this floor L1, L2. In this embodiment, the elevator system 1 is configured such that the elevator operation device 6 displays the direction of travel symbols 24, 26. Each elevator operation device 6 is activated, e.g., it is not in the energy saving state.

In a step S2, the method determines the status of the elevator system 1. In one embodiment, this status information is available in the elevator controller 13. The elevator system 1 can be in the normal operation mode or in the emergency operation mode. The emergency operation mode is identified, for example, when a technician has activated the maintenance mode or when the building management system has transmitted a fire alarm.

In a step S3, the method queries this status information. If the elevator system 1 is in the emergency operation mode, this represents operational disruption in the elevator system 1, and the elevator controller 13 actuates the elevator operation devices 6 by means of a corresponding control signal. In this case, the method proceeds along the “yes” branch to a step S4. If, on the other hand, there is no disruption, the elevator system 1 is in the normal operation mode and the method proceeds along the “no” branch to a step S5. In this case too, the elevator controller 13 actuates the elevator operation devices 6 by means of a corresponding control signal.

In step S4, the method causes the emergency operation message to be displayed. As explained in connection with FIG. 3, the emergency operation message can comprise a notification symbol 36, which has the meaning of a prohibiting symbol or warning symbol. In step S5, the method causes the direction of travel symbols 24, 26 to be displayed. The symbols (24, 26, 36) displayed in steps S4 and S5 are displayed until the relevant status changes. The method ends at step S6.

If the elevator system 1 is in the normal operation mode, a passenger P can call an elevator by inputting the desired direction of travel. For this purpose, the passenger P touches the touch surface 35 at the point at which the user interface 34 displays the desired direction of travel symbol 24, 26. The control device 50 of the touch screen 46 identifies the point at which the touch occurs and to which symbol (24, 26) this point is assigned. The central control and processing device 43 then actuates the electroacoustic transducer 52 to generate a voice message which indicates the direction of travel assigned to this point. At the same time, haptically perceptible feedback is generated by the actuator 62. If the finger touches the (upward) direction of travel symbol 24, for example, the haptically perceptible feedback and the voice message “up” (or similar other wording of the direction information) are generated. If the finger is on the desired direction of travel symbol 24, 26, the passenger can increase the pressure force at this point, which is identified by the force measuring device 60, in order to input the direction of travel.

As explained in connection with FIG. 2, the user interface 34 can display additional fields and/or symbols (28, 30, 32). The touching of these fields and/or symbols is also confirmed in one embodiment by haptically perceptible feedback and a voice message. For example, the information field 30 can be used in one embodiment to display floor-specific and/or building-specific information; for example, it can be indicated in the information field 30 that the office of a lawyer is located on a particular floor. If the passenger P touches the information field 30, first the haptically perceptible feedback and a voice message corresponding to the information field 30 are generated. If the passenger P then increases the pressure force, this is considered to be a request to travel in the direction of the floor. Additional input of the direction of travel by means of one of the direction of travel symbols 24, 26 is no longer necessary in this case. This simplifies the call input for passengers P with and without physical disabilities.

1. An elevator system, comprising:
an elevator controller;
an elevator car which can be moved, in a manner controlled by the elevator controller, between floors, wherein a car call device which is communicatively connected to the elevator controller and is intended for inputting a destination floor is arranged in the elevator car;
elevator operation devices which are communicatively connected to the elevator controller and are arranged on the floors for the input of an elevator call, wherein an elevator operation device comprises a touch-sensitive screen system which includes a substantially smooth touch surface and is configured to respond with haptically perceptible feedback to a touch of the touch surface by a passenger,
wherein the elevator controller is configured to actuate an elevator operation device in a normal operation mode of the elevator system by means of a first control signal such that the screen system displays at least one call symbol on a user interface, and
wherein the elevator controller is configured to actuate an elevator operation device in an emergency operation mode of the elevator system by means of a second control signal such that the screen system displays an emergency operation message on the user interface.

2. The elevator system according to claim 1, wherein the screen system is also configured to respond with the haptically perceptible feedback when the passenger touches the at least one call symbol and to identify input of an elevator call when the touch reaches a specified pressure force.

3. The elevator system according to claim 1, wherein the touch-sensitive screen system comprises an actuator which, when actuated by a control voltage, causes a surface of the screen system to vibrate, the vibration comprising the haptically perceptible feedback, and wherein the touch-sensitive screen system comprises a force measuring device and a control device, the force measuring device being configured to measure a pressure force with which the passenger presses on the touch surface of the touch-sensitive screen system, and the control device being configured to register the measured force as a triggering force only when the measured pressure force reaches a specified threshold value.

4. The elevator system according to claim 1, wherein the elevator operation device comprises a communication device for communication with the elevator controller, and a central control and processing device which communicates with the communication device, and is communicatively connected to the screen system, the central control and processing device being configured to:
in a normal operation mode, when actuated by the elevator controller by a first control signal, actuate the screen system such that the user interface displays the at least one call symbol, and
in the emergency operation mode, when actuated by the elevator controller by a second control signal, actuate the screen system such that the screen system displays the emergency operation message on the user interface.

5. The elevator system according to claim 1, wherein the elevator operation device comprises an audio device for a voice message, the elevator operation device being configured to generate the voice message in connection with the haptically perceptible feedback.

6. The elevator system according to claim 1, wherein the elevator controller is configured to actuate an elevator operation device in the normal operation mode such that the screen system displays at least one information field in addition to the at least one call symbol, the screen system being configured to respond with the haptically perceptible feedback when a passenger touches the at least one information field.

7. The elevator system according to claim 6, wherein an information field displays information regarding a specified floor, an elevator operation device being configured, when the passenger touches the information field, to generate the haptically perceptible feedback and a voice message assigned to the information field and, if the pressure force is equal to a specified threshold value, to register a request to travel in the direction of the specified floor.

8. The elevator system according to claim 1, wherein the elevator operation device comprises a reader, communicatively connected to the elevator controller, for credentials of the passenger, the elevator operation device being configured to authorize the input of an elevator call when the credentials are valid.

9. The elevator system according to claim 1, wherein the at least one call symbol is a direction of travel symbol.

10. An elevator operation device for inputting an elevator call in an elevator system, comprising:
a communication device which is configured to communicate with an elevator controller of the elevator system;
a central control and processing device which is communicatively connected to the communication device;
a touch-sensitive screen system which is equipped with a substantially smooth touch surface and is communicatively connected to the communication device,
wherein the screen system is configured to respond with haptically perceptible feedback to a touch of the touch surface by a passenger,
wherein the central control and processing device is configured, when actuated by the elevator controller in a normal operation mode of the elevator system, to actuate the screen system such that the screen system displays at least one call symbol on a user interface, and
wherein the central control and processing device is configured, when actuated by the elevator controller in an emergency operation mode of the elevator system, to actuate the screen system such that the screen system displays an emergency operation message on the user interface.

11. The elevator operation device according to claim 10, wherein the central control and processing device is also configured to respond with the haptically perceptible feedback when the passenger touches the at least one call symbol and to identify input of an elevator call when the touch reaches a specified pressure force.

12. A method for operating an elevator system comprising an elevator car, an elevator controller and elevator operation devices which are communicatively connected to the elevator controller and are arranged on floors for the input of an elevator call, wherein an elevator operation device has a touch-sensitive screen system which is equipped with a substantially smooth touch surface and is configured to respond with haptically perceptible feedback to a touch of the touch surface by passenger, wherein the method comprises:
actuating an elevator operation device by means of a first control signal generated by the elevator controller in a normal operation mode of the elevator system, whereupon a central control and processing device of the elevator operation device causes at least one call symbol to be displayed on a user interface of the screen system; and
actuating an elevator operation device by means of a second control signal generated by the elevator controller in an emergency operation mode of the elevator system, whereupon the central control and processing device of the elevator operation device causes an emergency operation message to be displayed on the user interface of the screen system.

13. The method according to claim 12, further comprising generating the haptically perceptible feedback when the passenger touches the at least one call symbol and identifying input of an elevator call when the touch reaches a specified pressure force.

14. The method according to claim 13, wherein the haptically perceptible feedback is generated by an actuator of the touch-sensitive screen system which, when actuated by a control voltage, causes the touch surface to vibrate, and wherein the specified pressure force is determined by a force measuring device of the screen system, wherein the force measuring device is configured to measure a pressure force with which the passenger presses on the touch surface of the touch-sensitive screen system, and wherein a control device of the screen system is configured to register the measured force as a triggering force only when the measured pressure force reaches a specified threshold value.

15. The method according to claim 12, further comprising generating a voice message by an audio device of the elevator operation device, wherein the voice message is generated in connection with the haptically perceptible feedback.
